(19) United States
(12) Patent Application Publication
(10) Pub. No.: US 2024/0317266 A1
(43) Pub. Date: Sep. 26, 2024

(54) SYSTEMS AND TECHNIQUES FOR REMOTE ASSISTANCE FOR AUTONOMOUS VEHICLES

(71) Applicant: GM Cruise Holdings LLC, San Francisco, CA (US)

(72) Inventors: Daniel Kan, Atlantic Beach, FL (US); Anisha Mocherla, Chicago, IL (US); Michael Rusignola, Burlingame, CA (US)

(21) Appl. No.: 18/189,108

(22) Filed: Mar. 23, 2023

(51) Int. Cl. B60W 60/00; B60W 30/06; B60W 50/02

(52) U.S. Cl. CPC B60W 60/0018; B60W 30/06; B60W 50/0205; B60W 60/0053; B60W 2556/45

(57) ABSTRACT

Systems and techniques are disclosed for providing remote assistance to autonomous vehicles. An example method can include navigating an autonomous vehicle (AV) to a facility and/or a location within the facility; determining an error condition encountered by the AV in the facility, the error condition including a failure to perform a maneuver in the facility and/or a restriction of the AV preventing the AV from performing the maneuver in the facility; in response to the error condition, initiating a switch of an operation of the AV from an autonomous operation to a human-controlled operation; receiving, from a human operator, an instruction for the AV to perform one or more maneuvers determined to resolve the error condition, wherein the one or more maneuvers include the maneuver or an alternative maneuver; and triggering the AV to perform the one or more maneuvers based on the instruction.

### BACKGROUND

### 1. Technical Field

The present disclosure generally relates to providing remote assistance to autonomous vehicles. For example, aspects of the present disclosure relate to techniques and systems for providing remote assistance to autonomous vehicles during certain conditions such as autonomous maneuver errors in parking facilities.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may involve collecting and processing large quantities of data from various sensors of an AV such as, for example and without limitation, camera sensors, radio detection and ranging (RADAR) sensors, inertial measurement units (IMUs), and/or light detection and ranging (LiDAR) sensors, among others.

### BRIEF DESCRIPTION OF THE DRAWINGS

Illustrative embodiments of the present application are described in detail below with reference to the following figures:

FIG. 1 illustrates an example system environment that can be used to facilitate autonomous vehicle (AV) navigation and routing operations, according to some examples of the present disclosure;

FIG. 2 illustrates an example environment associated with an error condition encountered by an autonomous vehicle, according to some examples of the present disclosure;

FIG. 3 illustrates another example environment associated with an error condition encountered by an autonomous vehicle, according to some examples of the present disclosure;

FIG. 4 is a diagram illustrating an example planning system implemented by an autonomous vehicle to perform various planning operations, according to some examples of the present disclosure;

FIG. 5 illustrates an example process for requesting and obtaining remote assistance by an autonomous vehicle, according to some examples of the present disclosure; and

FIG. 6 illustrates an example processor-based system with which some aspects of the subject technology can be implemented, according to some aspects of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the environment and navigate the environment without human input (or with minimal human input). Automation technologies enable AVs to drive on roadways and perceive the surrounding environment accurately and quickly, including obstacles, signs, road users and vehicles, traffic lights, semantic elements, boundaries, among others. In some cases, AVs can be used to pick-up passengers and/or cargo and drive the passengers and/or cargo to selected destinations.

An AV can include various types of sensors such as, for example and without limitation, a camera sensor, a light detection and ranging (LIDAR) sensor, a radio detection and ranging (RADAR) sensor, an acoustic sensor (e.g., an ultrasonic sensor, a microphone, etc.), an inertial measurement unit (IMU), among others. The AV can use such sensors to collect data and measurements in a driving environment, which the AV can use to perform AV operations such as navigation. The sensors can provide the data and measurements to an internal computing system of the AV that can use the data and measurements to control a mechanical system of the AV, such as a vehicle propulsion system, a braking system, or a steering system.

AV navigation systems can collect data about a surrounding environment and use the data to reason about objects/entities in the environment for the purpose of making routing and navigation decisions and controlling an operation of an AV. In some instances, AV navigation systems may malfunction and/or encounter errors for various reasons and/or under various conditions. For example, an AV navigation system may malfunction or produce a navigation error when the AV encounters unknown objects or scenarios (e.g., objects or scenarios that are not known and/or recognized by the AV navigation system) that may frustrate any perception, prediction, and/or planning operations of the AV. In such situations, the AV may be unable to continue autonomous operations, may need to implement certain operations to avoid such situations, or may require manual input from a human such as a human driver/navigator or controller. In many cases, the AV may be paralyzed or unable to complete a trip and/or maneuver until a human intervenes. The AV may have to wait for the human to intervene, which may cause delays, impact traffic conditions, and/or impact the experience of any passengers of the AV or users relying on the AV for a particular service.

Described herein are systems, apparatuses, processes (also referred to as methods), and computer-readable media (collectively referred to as “systems and techniques”) for providing remote assistance (e.g., via a pit crew operator or remote assistance (RA) operator) to an AV during an error condition, such as a malfunction or error (e.g., during autonomous navigation) in a scene, such as a facility (e.g., parking or storage facility). For example, the systems and techniques described herein can be used to detect when an AV experiences an error condition (e.g., a condition that may require human intervention to perform or complete a trip of the AV, perform or complete an operation and/or maneuver of the AV, and/or control the AV until the error condition is absent and/or the AV overcomes or resolves the error condition), and automatically request assistance from a remote assistance (RA) operator that can provide the AV support to resolve the error condition. For example, an AV may encounter a driving scenario that the AV may not recognize, understand, and/or determine how to handle (e.g., a construction road closure, a scene without lane boundaries and/or other traffic controls/cues, etc.) and/or a driving scenario that may not be supported by a software of the AV, such as the AV's planning stack. In this example, the AV may automatically request assistance from an RA operator, which can provide instructions to the AV for resolving the issue encountered by the AV in the driving scenario. The AV can update a navigation and/or operation of the AV based on any such instructions received from the RA operator to resolve the issues encountered by the AV. For example, the RA operator can provide commands and/or instructions to the AV indicating maneuvers and/or paths to navigate through (or around) the driving scenario, which the AV can implement to resolve the issues in the driving scenario.

As discussed above, an AV may request assistance from an RA operator or pit crew operator while autonomously navigating a real-world environment to resolve certain error conditions, such as AV malfunctions. In some cases, the types of error conditions that an AV may encounter in a real-world environment may depend on the context of the AV and/or the type of environment. For example, the error conditions encountered by an AV in a road may differ from the types of error conditions the AV may encounter in facilities (also parking facilities, storage facilities) that the AV can use to park and/or that store or house AVs, such as a fleet of AVs. To illustrate, a fleet of AVs may be stored in various types of facilities including, but not limited to, an indoor parking structure, an outdoor parking lot, an AV service facility, and/or any area with adequate space to store AVs. Some of the AVs may not be able to navigate and/or park in such facilities without assistance from a human (e.g., without human input) using a combination of sensors, mapping systems, and navigation algorithms. In some cases, an AV may be able to navigate and/or park in such facilities but may encounter error conditions at any time when trying to autonomously navigate and/or park in such facilities.

In some examples, an AV may encounter an error condition when attempting to perform (or when the AV determines that it needs to perform) certain types of maneuvers and/or certain types of maneuvers in a particular type of facility, such as a parking facility. Non limiting examples of the types of maneuvers that may trigger an error condition for an AV can include entering or exiting a parking facility (e.g., ingress or egress of the parking facility), parking (e.g., parking in a parking spot, parallel parking, parking in any open area with adequate space for the AV), unparking, queuing, and navigating to a service or detailing location within a facility, among others.

In some examples, an AV may encounter error conditions when navigating parking facilities. For example, when an AV approaches a parking facility, the AV may scan the area using sensors to determine the location and layout of the parking facility. The AV may use sensors (e.g., one or more cameras, LIDARs, RADARs, ultrasonic sensors, and/or GPS receivers) to gather information about the surrounding environment (e.g., objects in the environment, other vehicles in the environment, semantic meaning of elements in the environment, boundaries of semantic elements in the environment, scene geometries, events and/or activity in the environment, etc.), which the AV can use to identify a parking space in the parking facility and navigate to the parking. Once the AV has approached the parking space, the AV may begin maneuvering into the parking space. In some instances, as the AV approaches the parking space, the AV can use sensors to detect any obstacles or other vehicles that may create obstacles or the AV may need to avoid when navigating the environment. The AV can slow down and carefully navigate into the space, adjusting its position as needed.

However, in some cases, while navigating a facility, the AV may encounter error conditions (e.g., scenarios or malfunctions that may require human input and/or assistance). As discussed above, there are various types of error conditions that an AV may encounter, and there can even be different types of error conditions that an AV may encounter in certain locations, such as a facility, as opposed to other locations, such as a road or other real-world environment. For example, in a parking facility, an AV may need to be parked within a certain proximity to other AVs, structures, and/or objects. During autonomous navigation, an AV may have a configured restriction that specifies a minimum distance the AV needs to maintain from other obstacles (e.g., other vehicles, objects, pedestrians, agents, structures, etc.). However, to navigate the parking facility and/or park in a space in the parking facility, the AV may need to approach one or more obstacles within a proximity that exceeds (e.g., is lower than) and/or violates the configured restriction specifying the minimum distance to other obstacles. As a result, the AV may be unable to navigate and/or park in the parking facility or may encounter an error condition when the AV determines that it needs to exceed or violate the minimum distance restriction to navigate and/or park in the parking facility. As described herein, an error condition may also be any scenario where the AV software is working as intended (e.g., the AV software is not malfunctioning), but there may be unexpected obstacles encountered by the AV (e.g., construction cone, obstacle, etc.), and/or the AV may need human input to address a condition, event, and/or issue.

In above example, the AV can automatically request assistance from an RA operator or pit crew operator in response to determining and/or encountering the error condition. The RA operator or pit crew operator can provide instructions to the AV that the AV can use to navigate and/or park in the parking facility. In some cases, the RA operator or pit crew operator can take control of the AV to assist the AV in navigating and/or parking in the parking facility. The RA operator or pit crew operator can additionally or alternatively may override the minimum distance restriction (and/or any other restriction) of the AV to help or allow the AV to navigate and/or park in the parking facility and/or force the AV to navigate and/or park in the parking facility even if such navigation and/or parking would cause the AV to exceed or violate the minimum distance restriction and/or come within a proximity to any obstacles in the facility that is less than the minimum distance restriction.

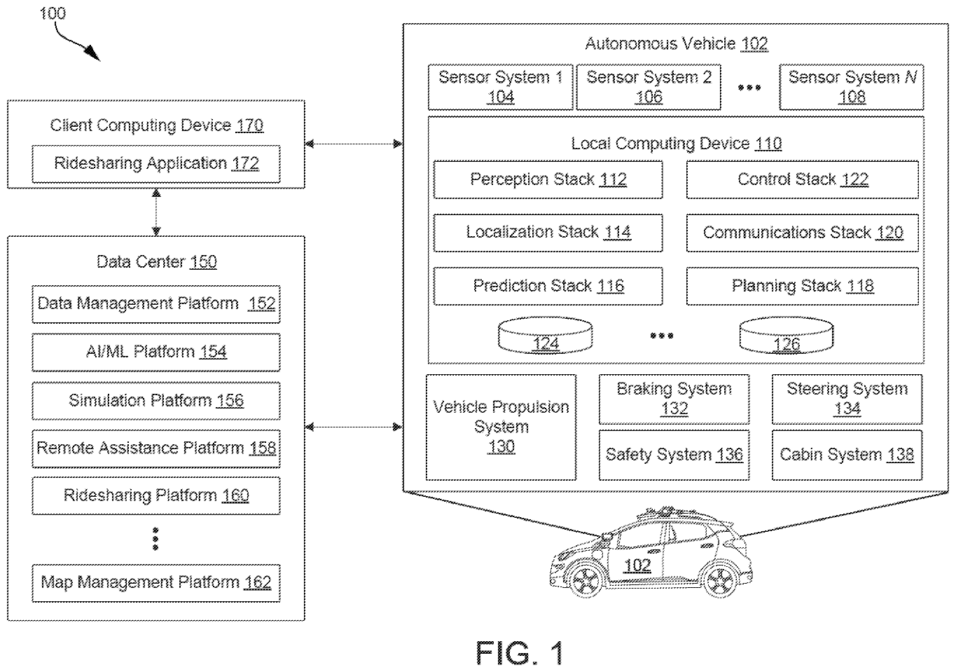

Examples of the systems and techniques described herein are illustrated in FIG. 1 through FIG. 6 and described below.

FIG. 1 illustrates an example of an AV environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are not limiting and provided for explanation purposes. Other examples may include different numbers and/or types of elements, but one of ordinary skill in the art will appreciate that such variations do not depart from the scope of the present disclosure.

In this example, the AV environment 100 includes an AV 102, a data center (also autonomous vehicle fleet management device, autonomous vehicle fleet management system, management system) 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise inertial measurement units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack 116 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan Wi-Fi network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), BLUETOOTH®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a

Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

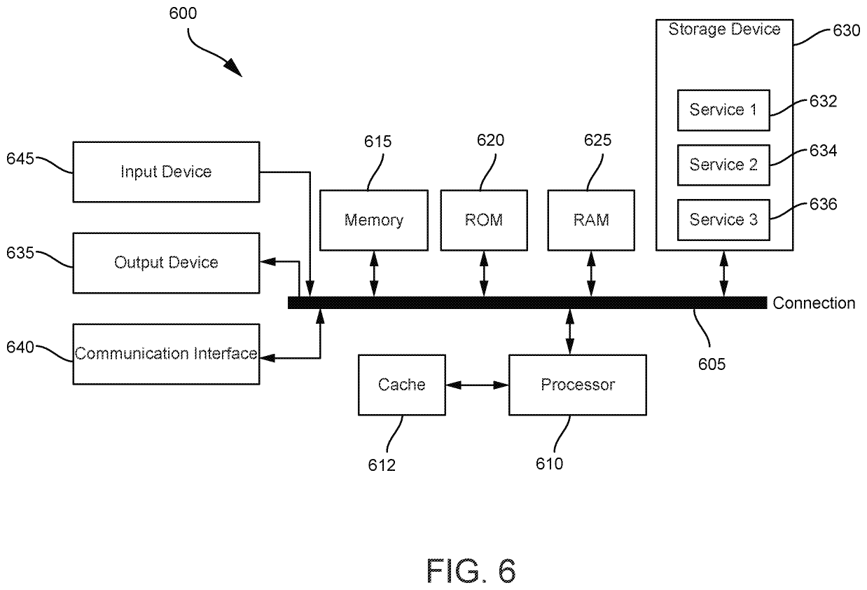

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

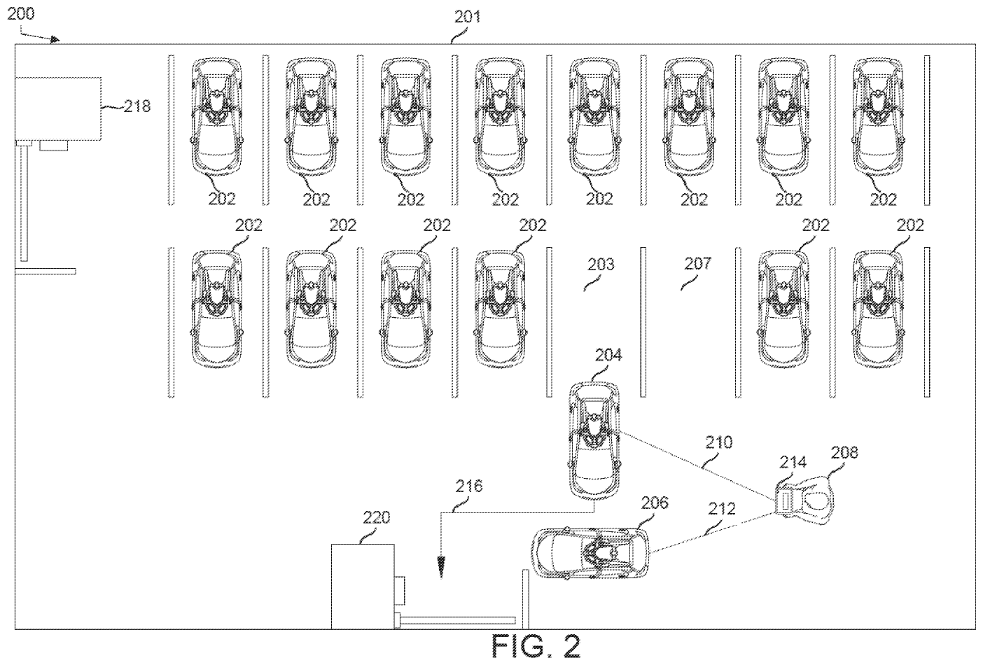

FIG. 2 illustrates an example environment 200 for providing remote assistance to one or more autonomous vehicles (AVs) in a facility 201 upon detecting an error condition, according to some examples of the present disclosure. An error condition can include any condition where (and/or in which) an AV may need to implement a maneuver and/or parameter that violates a restriction configured in a software of the AV, where (and/or in which) the AV may not be able to continue and/or complete a trip and/or maneuver autonomously, where (and/or in which) the AV encounters an unexpected condition, and/or where (and/or in which) the AV may need human assistance to continue and/or complete the trip and/or maneuver.

In this example, the environment 200 includes a facility 201 (e.g., a parking facility, storage area, outdoor parking area, parking structure, parking lot, service facility, charging facility, etc.) used by AVs to park, charge, and/or receive service. The facility 201 can include an area with adequate space to park and/or store the AVs 202. As illustrated in FIG. 2, the facility 201 includes parking spaces with lines or boundaries that indicate designated regions of space (e.g., parking spaces) for each AV to park within. In other instances, the facility 201 may not include designated regions of space and each AV may be parked in any manner (e.g., any location and/or orientation) with adequate space for the AV.

As described herein, the AVs 202 may autonomously navigate within the facility 201 and perform maneuvers including, but not limited to, ingress, egress, queuing, parking, and/or intra-facility maneuvers (e.g., autonomously navigating from one location to another within the facility 201). For example, an AV may maneuver to a detailing area (not illustrated) for cleaning the AV or a charging area for battery charging. The autonomous vehicles AV 202, AV 204, and AV 206 illustrated in FIG. 2 can include any AV or type of AV such as, for example the AV 102 illustrated in FIG. 1 or an equivalent AV.

In some aspects, there may be one or more entrances 218 for an AV to enter or ingress the facility 201. In some cases, the one or more entrances may also be used to exit the facility 201. In other cases, there may be one or more exits 220 for an AV to exit or egress the facility 201. In some examples, the entrance 218 and exit 220 may include a barrier gate as illustrated in FIG. 2, an attendant (e.g., human attendant), an exit ramp, a merge area, and/or other visual or sensory indicators (e.g., visual signs, designated lanes, lights, audio, etc.) that designate entrance 218 as an entry point and exit 220 as an exit point. In some examples, the AVs may use the visual or sensory indicators to autonomously egress or ingress via exit 220 or entrance 218, respectively.

As discussed above, an AV may encounter an error condition (e.g., one or more scenarios, malfunctions, errors, and/or situations) in which the AV may need or require assistance from an external source, such as a remote assistance (RA) operator 208. For example, an AV may encounter an error condition because the AV may not be able to autonomously navigate in the facility 201 and/or perform a particular maneuver in the facility 201, such as parking, ingress, egress, unparking, queuing, etc. In some cases, the RA operator 208 can include a pit crew operator, a remote human controller, a technician, service personnel, an engineer, or any other person capable of using a device 214 to communicate (e.g., transmit navigation instructions) with one or more AVs in the facility 201 to resolve the error condition and/or control the AV during the error condition. The RA operator 208 can use the device 214 to communicate with one or more AVs in the facility 201, such as AV 204, AV 206, and/or any of the AVs 202. For example, the RA operator 208 can use the device 214 to send instructions/commands to an AV in the facility 201 and/or otherwise control the AV in the facility 201.

The device 214 can include a computer, tablet, server, smartphone, or any electronic device capable of communicating with one or more AVs in the facility 201 (e.g., via a network and/or backend service that communicates with the one or more AVs). The local computing device 110 (e.g., communications stack 120) of an AV may receive one or more instructions/commands from the device 214 to perform one or more operations and resolve the error condition. In some examples, the device 214 and the AV communicating with the device 214 can be connected to the same network (e.g., a same Wi-Fi or cellular network) or different networks. In some cases, the device 214 may use other types of wireless signals including, but not limited to, BLUETOOTH®, cellular (e.g., 4G, 5G, LTE), satellite, Near Field Communication (NFC), Zigbee, and/or infrared communication to communicate with an AV.

The RA operator 208 may be located (e.g., physically located) within the facility 201 or may be located at a remote location (e.g., not within the facility 201). In some cases, if the RA operator 208 is at a remote location, the device 214 may use one or more networks, such as the Internet, a cloud service, and/or a server to communicate with any AVs in the facility 201.

As illustrated in FIG. 2, the AV 204 has unparked from a parking space 203 and is autonomously navigating towards the exit 220, as illustrated via trajectory 216, to exit the facility 201. The AV 206, which is unparked from the parking space 207, is stopped (e.g., due to an error condition) at a location near the AV 204 (e.g., within a proximity to and/or relative to). The AV 206, by being stopped and within a position relative to the AV 204 and/or the trajectory 216 of the AV 204 (e.g., within the trajectory 216 of the AV 204, within a proximity to the trajectory 216, within a proximity to the AV 204, and/or within a position relative to the trajectory 216 and/or a position of the AV 204), can trigger an error condition at the AV 204 which can cause the AV 204 to also stop. In other words, the AV 206 illustrated in FIG. 2 is preventing the AV 204 from continuing along the trajectory 216 and autonomously navigating to the exit 220 (e.g., via trajectory 216). In some cases, the AV 204 may be unable to proceed to the exit 220 because the AV 204 may need to navigate within a distance of the AV 204 and/or an obstacle in the exit 220 that is less than a minimum distance restriction configured on the AV 204. Thus, the AV 204 may encounter an error condition based on a determination that the minimum distance restriction prevents the AV 204 from navigating to the exit 220.

For example, the AV 204 may be configured (e.g., via software stored on local computing device 110) to implement a restriction that specifies that the AV 204 must maintain a minimum distance from other obstacles (e.g., other objects and/or vehicles, pedestrians, etc.) in the scene. If the distance between the AV 204 and an obstacle in a scene is below the minimum distance specified by the restriction, the AV 204 may encounter an error condition, which can prevent the AV 204 from continuing a current operation of the AV 204. The AV 204 may even need to or be forced to stop (e.g., stay in position) to avoid violating the restriction. To resolve the error condition, the AV 204 can autonomously request assistance from a human operator, such as an RA operator (e.g., RA operator 208) or pit crew operator, which can provide instructions/commands to the AV 204 to resolve the error condition and/or control the AV 204 until the error condition is resolved.

In the example shown in FIG. 2, the distance between the AV 206 and the AV 204 may be less than the minimum distance specified by a restriction of the AV 204. As a result, the AV 204 may experience an error condition. For example, the AV 204 may stop in place (e.g., stop autonomously operating or maneuvering within the facility 201) to prevent the AV 204 from violating the restriction. The AV 204 may automatically inform the human operator (e.g., RA operator 208) of the error condition. For example, the AV 204 can request assistance from the human operator (e.g., RA operator 208) to resolve the error condition. In some examples, the AV 204 can provide the human operator (e.g., RA operator 208) any information associated with the error condition, such as a cause of the error condition (e.g., the relevant restriction, error, and/or condition), the state of the AV 204 (e.g., the pose of the AV 204, the trajectory of the AV 204, sensor data collected by the AV 204, etc.). The human operator may send instructions (e.g., via the device 214) to the AV 204 specifying how to result the error condition and/or controlling and/or overriding the autonomous operation of the AV 204 to resolve the error condition.

For example, the RA operator 208 may use the device 214 provide instructions/commands to the AV 204 via a backend service that communicates with the AV 204. The instructions/commands can control and/or override the autonomous operation and/or navigation of the AV 204. For example, the instructions/commands can control and/or override a restriction and/or operation of the perception stack 112, the planning stack 118, the prediction stack 116, the vehicle propulsion system 130, the braking system 132, and/or the steering system 134 of the AV 204.

In some examples, the RA operator 208 may similarly communicate with the AV 206 (e.g., as illustrated via the signal 212) to provide information and/or instructions/commands to the AV 206, such as instructions/commands to control and/or override the autonomous operation and/or navigation of the AV 206. Thus, the RA operator 208 may help the AV 206 and/or the AV 204 navigate and/or maneuver within the facility 201, and enable the AV 204 to maneuver via trajectory 216 to the exit 220, despite any restrictions in the software of the AV 206 or the AV 204. For example, the RA operator 208 may control and/or maneuver the AV 206 and/or the AV 204 to help the AV 204 and/or the AV 206 resolve the error condition, such as be navigating to the exit 220 according to a specific exit sequence. This can quickly resolve the error condition and ensure that the AV 204 and/or the AV 206 do not remain stopped for longer, potentially blocking other traffic in the facility 201. To illustrate, based on an instruction/command from the RA operator 208, the AV 204 may restart autonomous operation and exit the facility 201, and the AV 206 may proceed to the exit 220 after the AV 204, or vice versa. In some examples, the RA operator 208 may remotely move the AV 204 and/or AV 206 such that the distance between the AV 204 and the AV 206 exceeds the minimum distance defined by a restriction configured on the AV 204 and/or the AV 206, and both vehicles are able to autonomously navigate.

In some cases, there may be one or more other restrictions, such as safety constraints, and/or autonomous features of any of the AVs 202, the AV 204 and/or the AV 206 that may be disabled, overridden, and/or temporarily modified by the RA operator 208 to resolve one or more error conditions involving any of the AVs 202, the AV 204, and/or the AV 206.

The environment 200 provides an example error condition in which an AV may request assistance from a human operator (e.g., RA operator 208). However, other examples may include other error conditions. For example, the environment can include other error conditions and/or an AV may encounter other error conditions. To illustrate, as the AVs 202 enter the facility 201 (e.g., via entrance 218) to park, the AVs 202 may queue within the facility 201 to park in respective parking spaces and navigate to the respective parking spaces according to a particular sequence associated with the queue. In some cases, the RA operator 208 may command (e.g., via the device 214) each of the A Vs 202 to queue, unqueue, and/or navigate from a queue to a respective parking space at a particular time and/or in a particular order. In other words, the RA operator 208 may orchestrate or send multiple commands to the AVs 202 to navigate the facility 201 and/or park in specific parking spaces within the facility 201 (e.g., the RA operator 208 may instruct one AV to park in a particular space, another AV to park in another particular space, etc.).

In other examples, the RA operator 208 may instruct or control one or more AVs to navigate to particular positions within a servicing and/or charging area. For example, AVs attempting to stop at respective positions within servicing and/or charging areas of a facility may encounter error conditions that may prevent them from navigating to the particular positions within the servicing and/or charging areas of the facility. The error conditions can be triggered by one or more restrictions configured on the software of the AVs that may restrict a path and/or operation of the AVs to the respective positions within the servicing and/or charging areas and/or can be caused by one or more errors or failures encountered by the AVs, which may prevent the AVs from navigating to the respective positions within the servicing and/or charging areas. The AVs can contact an RA operator(s) to request assistance to address and/or resolve the error conditions. The RA operator(s) may send (e.g., via the device 214) commands to AVs in the facility to control and/or trigger the AVs to navigate to the respective positions within the servicing and/or charging areas of the facility.

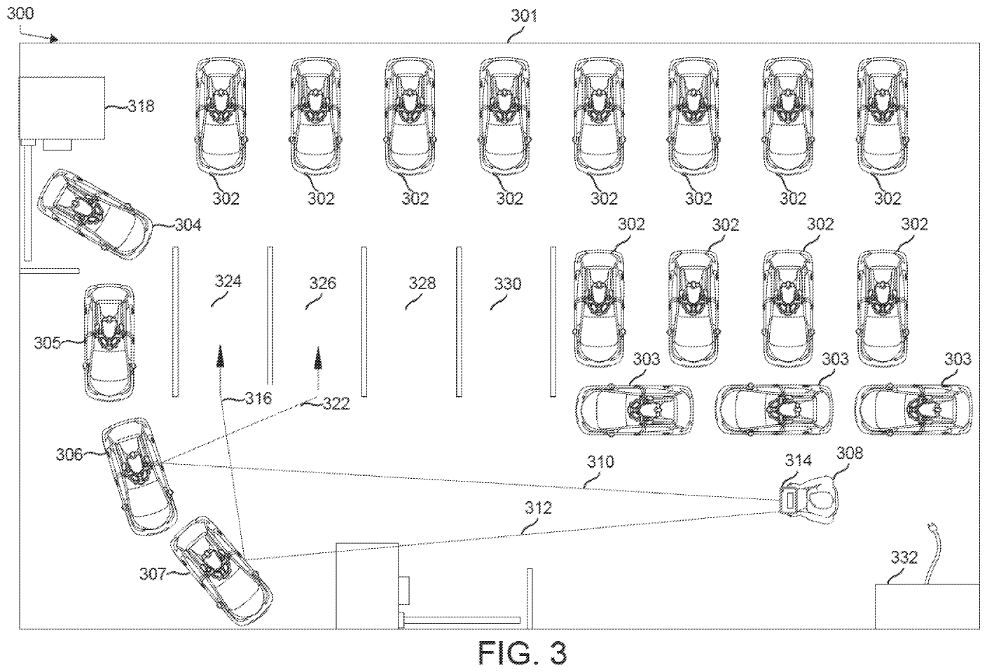

FIG. 3 illustrates another example environment 300 for providing remote assistance to autonomous vehicles in a facility 301, according to some examples of the present disclosure. In this example, the environment 300 may include AV charging and/or servicing areas/stations, which AVs can use to charge and/or receive one or more services. The AVs may encounter one or more error conditions when navigating the facility 301, as further explained below.

In some cases, the facility 301 may include a parking structure or parking lot for vehicles such as AVs. The facility 301 may include one or more parking spaces (e.g., parking spaces 324, 326, 328, 330) with lanes and/or boundaries, which may be detected (e.g., via perception stack 112) by the AVs. For example, the AVs 302 may autonomously navigate to respective parking spaces that are detected as empty. In some cases, the facility 301 may space to store one or more AVs with or without designated spaces and/or markings (e.g., pavement markings, lines, lane markings, etc.) for parking spaces. In some aspects, the A Vs 302 and the AVs 303 may detect (e.g., via perception stacks 112) and autonomously maneuver to any area within the facility 301 with adequate space for parking.

As illustrated in FIG. 3, the AVs 303 are oriented 90° Clockwise with respect to the AVs 302. The poses (e.g., locations and orientations) of the AVs 302 and the AVs 303 can include any poses that fit within an open area designated for parking within the facility 203 or determined to correspond to parking based on one or more cues such as, for example, a pose of any parked vehicles in the facility 301, a pose of any vehicles navigating in the facility, the relative position of one or more lanes and/or lane boundaries within the facility 301, a relative position of one or more ingress and/or egress locations, the trajectory of incoming and/or outgoing vehicles, one or more visual markings, one or more signs, and/or the relative position of one or more structures (e.g., escalators, columns, elevators, etc.).

In some examples, the AVs 302 and/or the AVs 303 may use machine learning algorithms to detect open (e.g., available) parking spaces in the facility 301, and/or optimize the vehicle pose (e.g., location and orientation) within any particular parking space (e.g., the machine learning algorithms may also account for the pose of other obstacles and/or vehicle to optimize the pose of a particular vehicle for a particular parking space). In some examples, the AVs 302 may autonomously navigate or maneuver within the facility 301 to reach an area where the AVs 302 can receive a particular service. For example, an AV may detect (e.g., via a local computing device 110) that a battery level of the AV is at or below a threshold and maneuver the AV to the charging station 332 in the facility 301, to charge a battery of the AV. In another example, an AV may detect a need for mechanical servicing or maintenance (e.g., cleaning, etc.) and autonomously navigate to a designated area within the facility 301 where the AV can receive that particular service. Some or all of these examples and/or scenarios may result in error conditions that may prompt a request to an RA operator 308 for remote assistance (e.g., to intervene and resolve the error conditions).

For example, the AVs 304, 305, 306, 307 may encounter a respective error condition when attempting to navigate to a respective parking space in the facility 301 and/or a particular area within the facility 301, such as the charging station 332. The AVs 304, 305, 306, 307 can send a request to the RA operator 308 for assistance in response to detecting the respective error condition. The RA operator 308 may send commands the AVs 304, 305, 306, 307 to assist the AVs 304, 305, 306, 307. For example, the RA operator 308 can issue commands to orchestrate a sequence of maneuvers for a desired outcome by the AVs 304, 305, 306, 307.

To illustrate, in FIG. 3, AVs 304, 305, 306, and 307 are entering the facility 301 via the entrance 318 and forming a queue to wait to navigate to destination locations within the facility, such as available parking spaces (e.g., open parking spaces 324, 326, 328, 330), the charging station 332, etc. The AVs 304, 305, 306, and/or 307 may encounter an error condition, such as a failure to complete an operation or maneuver, a failure to reach a location or a pose, a failure to follow a trajectory or path, and/or a restriction configured on the AV software that may prevent or prohibit an AV operation, maneuver, and/or path (e.g., because the AV may need to violate a restriction on a minimum distance between the AV and other objects/vehicles, the AV may need to reduce the speed of the AV to below a threshold, the AV may need to perform a turn that exceeds a maximum turn restriction and/or maximum steering angle restriction, etc.). In some cases, because of the error condition, the AVs 304, 305, 306 and/or 307 may be unable to autonomously navigate to respective destinations within the facility 301 and/or may need to stop until an RA operator can provide assistance.

In response to the error condition, the AVs 304, 305, 306, and/or 307 may send the RA operator 308 a request for remote assistance. The RA operator 308 may send commands to any of the AVs requesting assistance (or any AVs causing any of the AVs to request assistance) to resolve the error condition and/or direct such AVs to specific destinations within the facility 301. For example, the RA operator 308 may instruct AV 306 (e.g., via the device 314 which may transmit a wireless signal 310 to the local computing device 110 of the AV 306) to navigate to open parking space 326 via the trajectory 322, and instruct the AV 307 (e.g., via the signal 312) to navigate to the open parking space 324 via the trajectory 316. The RA operator 308 may resolve the one or more error conditions encountered by the AV 304, 305, 306, and/or 307, which may enable the vehicles to resolve the error condition and/or autonomously navigate to open parking spaces 324, 326, 328, and 330.

In some instances, the RA operator 308 may resolve an error condition encountered by a vehicle (e.g., AV 302, 303, 304, 305, 306, and/or 307) by controlling the vehicle (e.g., navigating the vehicle to another location or changing the orientation of the vehicle) such that the error condition is resolved and/or an autonomous state of the vehicle can be resumed. In some examples, the RA operator 308 may resolve an error condition encountered by a vehicle (e.g., AV 302, 303, 304, 305, 306, and/or 307) by modifying a software (e.g., perception stack 112, prediction stack 116, planning stack 118 or other software on local computing device 110) of the vehicle and/or overriding a restriction of a software of the vehicle, to allow the vehicle to perform one or more operations and/or maneuvers that would otherwise violate the unmodified software and/or the restriction overridden by the RA operator 308, and/or otherwise allow the vehicle to resume an autonomous operation and resolve the error condition. For example, the RA operator 308 may modify a restriction configured in a software of a vehicle (e.g., AV 302, 303, 304, 305, 306, and/or 307) to resolve an error condition encountered during an autonomous navigation and/or an autonomous maneuver.

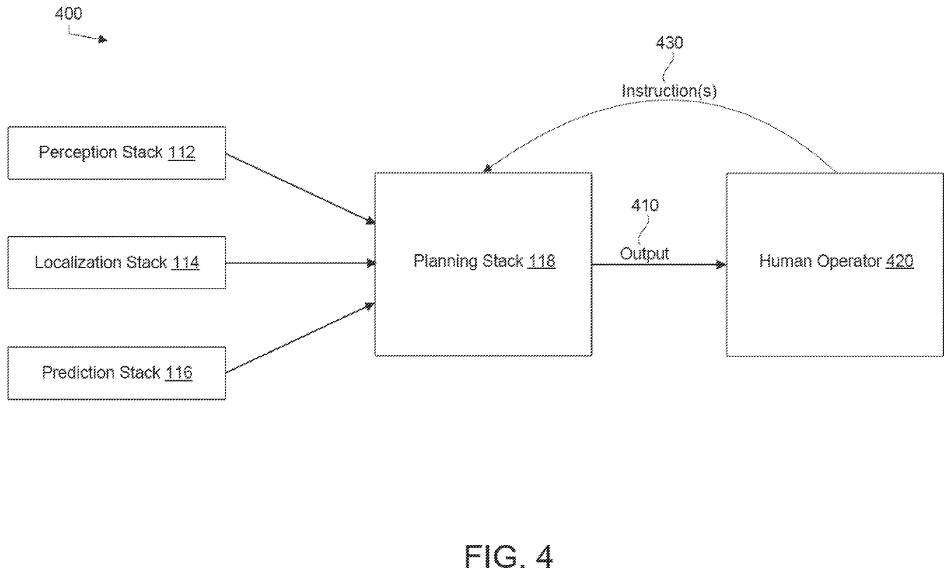

FIG. 4 is a diagram illustrating an example system 400 implemented by an AV (e.g., AV 102) to detect an error condition and request assistance from an RA operator, according to some examples of the present disclosure. In some examples, the system 400 can include or be part of the planning stack 118 of the local computing device 110 of the AV 102, as previously described.

As shown in FIG. 4, the planning stack 118 can receive data from the perception stack 112, the localization stack 114, and/or the prediction stack 116, which the planning stack 118 can use to generate one or more outputs 410 used to request assistance from an RA operator. The data from the perception stack 112, the localization stack 114, and/or the prediction stack 116 can include, for example and without limitation, a current and/or predicted pose (e.g., a position and orientation) of the AV 102, a current and/or predicted location of the AV 102, a current and/or predicted pose of one or more other scene elements (e.g., other vehicles, pedestrians, traffic signs, buildings, crosswalks, intersections, road objects, open parking spots, occupied parking spots, charging station, service center, etc.), a current and/or predicted location of the one or more other scene elements, a trajectory and/or route of the AV 102, a trajectory and/or state of other road elements (e.g., other vehicles in a parking area or parking facility such as facility 201 and facility 301 as illustrated in FIG. 2 and FIG. 3), a presence of one or more elements (e.g., objects, vehicles, crosswalks, intersections, parking spots, spaces, traffic signs, etc.) detected in a scene associated with the AV 102, visual markings and/or cues detected in the scene, data describing one or more aspects of the scene, a predicted status of the AV 102 and/or one or more elements in the scene of the AV 102, a predicted state (e.g., a predicted trajectory, operation, behavior, destination, change in state and/or status, etc.) of the AV 102 and/or one or more elements in the scene, and a predicted metric of the AV 102 and/or one or more elements in the scene, a semantic meaning of one or more scene elements detected in a scene, among others.

In some cases, the data from the perception stack 112, the localization stack 114, and/or the prediction stack 116 can include sensor data, such as measurements collected in a scene, image data collected in the scene, point clouds collected in the scene, etc. In other cases, the planning stack 118 can additionally or alternatively receive sensor data as inputs to the planning stack 118 from one or more sensors of the AV 102.

As discussed above, the planning stack 118 can determine how to maneuver and/or operate the AV 102 in an environment. For example, in a parking facility (e.g., facility 201 and facility 301 as illustrated in FIG. 2 and FIG. 3), the planning stack 118 can determine how the AV 102 may autonomously navigate or maneuver to an open parking space, unpark from a parking space, exit the parking facility, queue with other vehicles, or maneuver towards another area in the facility for service or maintenance (e.g., charging, cleaning, etc.). In some instances, the planning stack 118 may detect an error condition based on a determination that the AV 102 is unable to perform and/or complete a maneuver, navigate a particular scene, follow a particular trajectory or path, and/or reach a particular destination (and/or destination location or pose) without assistance (e.g., without human and/or remote assistance), and/or that doing so (e.g., performing and/or completing the maneuver, navigating the particular scene, following the particular trajectory or path, reaching the particular destination, etc.) may require the AV 102 to implement one or more parameters that conflict (e.g., exceed, violate, etc.) with one or more requirements configured on a software of the AV 102, such as a buffer distance requirement (e.g., a minimum distance the AV 102 must maintain between the AV 102 and other vehicles and/or road users), a minimum obstacle distance requirement (e.g., a requirement of a minimum distance the AV 102 must maintain between the AV 102 and other obstacles in a scene), a maximum turn requirement (e.g., a maximum turn angle, steering angle, and/or steering wheel angle that the AV 102 is allowed to reach/implement), a maximum or minimum speed of the AV 102 in one or more scenes and/or types of scenes, a safety requirement, etc.

In response to detecting the error condition, the planning stack 118 can generate an output 410 that can include a request for assistance from a human operator 420. The human operator 420 can include any user configured to receive (and/or access) requests for assistance from one or more AVs, such as AV 102. For example, the human operator 420 can include a remote assistance (RA) operator, a pit crew operator, and/or any other user or operator. In some examples, the human operator 420 can receive the output 410 and/or access the output 410 via a computing device such as, for example and without limitation, a laptop computer, a tablet computer, a smartphone, a desktop computer, a server computer, a controller system, a smart device, and/or any other computing device. In some cases, the human operator 420 can receive the output 410 and/or access the output 410 via an interface and/or an application system such as, for example and without limitation, a website/webpage, an application and/or application interface, an application programming interface (API), a database, etc.

The AV 102 (and/or the planning stack 118) can send (e.g., via the communications stack 120) the output 410 (e.g., including the assistance request) to the human operator 420 to initiate an assistance to resolve the error condition. In some cases, the output 410 can additionally or alternatively include an indication of the error condition. For example, the output 410 provided to the human operator 420 can indicate the error condition and any associated details which triggered the request for assistance. In some cases, the output 410 can include any other information about the AV 102, the error condition, and/or the scene of the AV 102, such as an operation of the AV 102, a pose of the AV 102, a location of the AV 102, sensor data collected by the AV 102, a trajectory of the AV 102, a description of the error condition, a state of the AV 102, a state of other vehicles and/or road users in the scene, a description of the scene, a description of a cause for the error condition, a description of one or more scene elements, etc.

In some cases, the output 410 sent to the human operator 420 can additionally or alternatively include one or more navigation and/or maneuver parameters and/or measurements, one or more restrictions associated with the AV 102, one or more rules (e.g., traffic rules, operation rules, etc.) of a scene associated with the AV 102, one or more routes, one or more requested operations, one or more instructions, one or more conditions, one or more navigation plans, and/or any other planning data.

The human operator 420 can receive the output 410 and send an instruction 430 to the planning stack 118 to control or modify an operation of the AV 102 to resolve the error condition, override a software restriction and/or parameter causing the error condition, and/or navigate the AV 102 until the error condition is resolved. In some examples, the human operator 420 can determine the instruction 430 based on information about the AV 102, the scene of the AV 102, and/or the error condition contained in the output 410 from the planning stack 118. For example, the human operator 420 can determine how to resolve the error condition based on sensor data included in the output 410, a description of the error condition (and/or its cause) in the output 410, a description of a scene of the AV 102 and/or one or more scene elements in the scene, a description of a state (e.g., a location, an orientation, a trajectory, a speed, etc.) and/or operation of the AV 102, a description of a state of one or more scene elements, a description of one or more software parameters of the AV 102, a description of one or more restrictions configured in a software of the AV 102, etc. Based on the determination of how to resolve the error condition, the human operator 420 can generate the instruction 430 for the AV 102. The instruction 430 can include one or more commands for the AV 102, one or more routes for the AV 102, planning data, one or more software overrides and/or software restriction overrides, one or more parameters, planning data, etc.

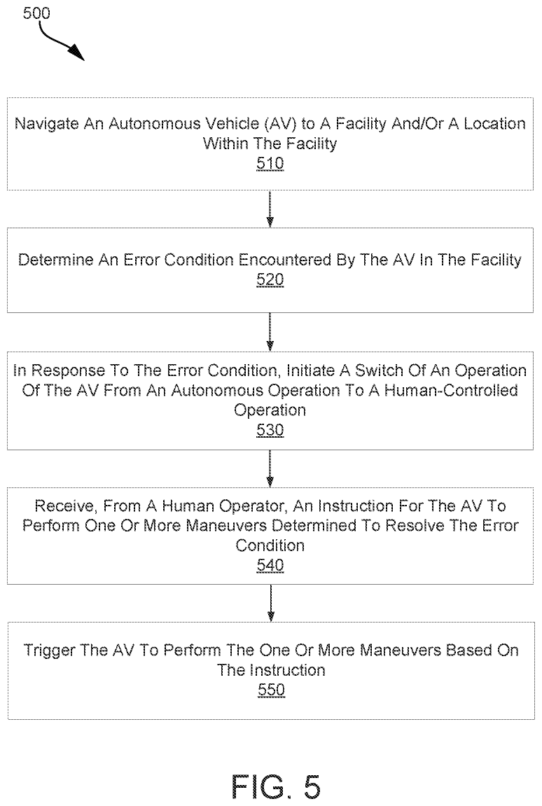

FIG. 5 illustrates an example process 500 for requesting and obtaining remote assistance by an autonomous vehicle, according to some examples of the present disclosure. At block 510, the process 500 can include navigating an AV (e.g., AV 102) to a facility and/or a location within the facility. For example, the process 500 can include navigating the AV to or through an entrance of the facility, to a particular queue of vehicles in or outside of the facility, a specific region of the facility, or a location outside or inside of the facility. The facility can include, for example, a parking structure or garage, a storage facility for vehicles and/or a fleet of vehicles, a parking lot, a location with vehicle charging stations, a location with vehicle servicing stations, etc. In some cases, the process 500 can include navigating the AV to a facility (e.g., facility 201, facility 301) by parking the AV, unparking the AV, queuing the AV, exiting or entering the facility, or intra-facility maneuvering (e.g., navigating within the facility), etc.

At block 520, the process 500 can include determining an error condition encountered by the AV. In some examples, the error condition can include a failure to perform a maneuver(s) in the facility and/or a restriction of the AV preventing the AV from performing the maneuver(s) in the facility. For example, the AV can encounter the error condition while autonomously navigating the facility based on a failure of the AV to perform and/or complete a maneuver, a software restriction configured on the AV, and/or one or more parameters that the AV may need to implement to perform a maneuver. In some cases, the error condition can be caused by a software of the AV. In some cases, the error condition may be caused by another vehicle (e.g., AV 206) or object within a proximity to the AV.

In some examples, determining the error condition can include determining that performing or completing the maneuver includes or requires violating the restriction of the AV (e.g., a software restriction of the AV). In some cases, the restriction of the AV can include a software restriction corresponding to the autonomous operation of the AV, such as a buffer distance restriction, a restriction on a minimum distance between the AV and one or more obstacles, a turning restriction (e.g., a restriction defining a maximum steering angle and/or steering wheel angle, etc.), a speed restriction (e.g., a minimum speed, a maximum speed, a maximum or minimum speed while turning or implementing a threshold steering angle and/or steering wheel angle), etc.

At block 530, the process 500 can include in response to the error condition, initiating a switch of an operation of the AV from an autonomous operation to a human-controlled operation. For example, the process 500 can include sending, to a human operator (e.g., human operator 420), such as an RA operator (e.g., RA operator 208) and/or a pit crew operator, a request for assistance and/or a request for the human-controlled operation. In some cases, initiating the switch can include requesting assistance from a human operator (e.g., human operator 420), such as a remote assistance operator and/or a pit crew operator.

At block 540, the process 500 can include receiving, from the human operator (e.g., human operator 420), an instruction for the AV to perform one or more maneuvers determined to resolve the error condition. In some examples, the instructions can include one or more commands for performing the one or more maneuvers, one or more parameters to implement to perform the one or more maneuvers, a restriction override that overrides or waives a software restriction that may prevent the AV from performing or completing the one or more maneuvers, planning data, and/or data for performing the one or more maneuvers. In some cases, the one or more maneuvers can include the maneuver associated with the error condition. In other cases, the one or more maneuvers can include an alternative maneuver that the AV can perform to resolve the error condition.

At block 550, the process 500 can include triggering the AV to perform the one or more maneuvers based on the instruction. For example, after receiving the instruction from the human operator, the AV can use the instruction to trigger the AV to implement a maneuver(s), such as navigating to a location, navigating away from an obstacle (e.g., a vehicle a pedestrian, a structure, etc.), maneuvering away from an obstacle, following a trajectory, overriding a restriction of a software of the AV, resume an operation of the AV, etc.

In some aspects, the process 500 can further include in response to performing the one or more maneuvers, switching the operation of the AV from the human-controlled operation to the autonomous operation. In some examples, the maneuver and/or the one or more maneuvers can relate to parking the AV, unparking the AV, entering the facility, exiting the facility, and/or queuing (e.g., forming part of a queue of vehicles and/or reaching a position within a queue of vehicles, waiting within a queue of vehicles, etc.).

In some aspects, the process 500 can include providing a pose and/or location of the AV within the facility to the human operator. In some cases, the pose and/or location of the AV can include a pose and/or location in space and/or a pose and/or location of the AV relative to one or more scene elements such as, a location within the facility, one or more obstacles (e.g., vehicles, pedestrians, signs, cones, columns, etc.) within the facility, one or more structures within the facility (e.g., a ramp, an ingress location, an egress location, an escalator, an elevator, a charging station, a service station, an assistance station, a door, etc.), a visual cue (e.g., visual markings, signs, etc.), and/or any other scene elements. In some aspects, the process 500 can include modifying the pose and/or location of the AV within the facility. For example, the process 500 can include using the instruction from the human operator to modify the pose and/or location of the AV within the facility. In some cases, modifying the pose and/or location of the AV can include navigating the AV from to the pose and/or location of the AV to a different pose and/or location, such as a destination pose and/or location within the facility or outside of the facility.

In some cases, the instruction from the human operator can provide an instruction or command for the AV to use to park at a specific location within the facility and/or to optimize a usage by the AV of an available space within the facility. In some examples, the instruction from the human operator can provide the AV an instruction or command that the AV can use to reach a station within the facility, such as a charging station, a ticket station, or a service station.

FIG. 6 illustrates an example processor-based system with which some aspects of the subject technology can be implemented. For example, processor-based system 600 can be any computing device making up the local computing device 110 of the AV 102 illustrated in FIG. 1, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: at least one memory; and at least one processor coupled to the at least one memory, the at least one processor configured to: navigate an autonomous vehicle (AV) to at least one of a facility and a location within the facility; determine an error condition encountered by the AV in the facility, the error condition comprising at least one of a failure to perform a maneuver in the facility and a restriction of the AV preventing the AV from performing the maneuver in the facility; in response to the error condition, initiate a switch of an operation of the AV from an autonomous operation to a human-controlled operation; receive, from a human operator, an instruction for the AV to perform one or more maneuvers determined to resolve the error condition, wherein the one or more maneuvers comprise the maneuver or an alternative maneuver; and trigger the AV to perform the one or more maneuvers based on the instruction.

Aspect 2. The system of Aspect 1, wherein the at least one processor is further configured to: in response to performing the one or more maneuvers, switch the operation of the AV from the human-controlled operation to the autonomous operation.

Aspect 3. The system of any of Aspects 1 or 2, wherein the maneuver relates to parking, unparking, entering the facility, exiting the facility, and queuing.

Aspect 4. The system of any of Aspects 1 to 3, wherein the determining the error condition comprises determining that performing or completing the maneuver includes violating the restriction of the AV, wherein the restriction of the AV comprises a software restriction corresponding to the autonomous operation of the AV.

Aspect 5. The system of any of Aspects 1 to 4, wherein initiating the switch comprises requesting assistance from the human operator.

Aspect 6. The system of Aspect 5, wherein the at least one processor is further configured to: provide at least one of a pose and a location of the AV within the facility to the human operator.

Aspect 7. The system of Aspect 6, wherein the at least one processor is further configured to: modify, via the instruction from the human operator, at least one of the pose and the location of the AV within the facility.

Aspect 8. A method comprising: navigating an autonomous vehicle (AV) to at least one of a facility and a location within the facility; determining an error condition encountered by the AV in the facility, the error condition comprising at least one of a failure to perform a maneuver in the facility and a restriction of the AV preventing the AV from performing the maneuver in the facility; in response to the error condition, initiating a switch of an operation of the AV from an autonomous operation to a human-controlled operation; receiving, from a human operator, an instruction for the AV to perform one or more maneuvers determined to resolve the error condition, wherein the one or more maneuvers comprise the maneuver or an alternative maneuver; and triggering the AV to perform the one or more maneuvers based on the instruction.

Aspect 9. The method of Aspect 8, further comprising: in response to performing the one or more maneuvers, switching the operation of the AV from the human-controlled operation to the autonomous operation.

Aspect 10. The method of any of Aspects 8 or 9, wherein the maneuver relates to parking, unparking, entering the facility, exiting the facility, and queuing.

Aspect 11. The method of any of Aspects 8 to 10, wherein the determining the error condition comprises determining that performing or completing the maneuver includes violating the restriction of the AV, wherein the restriction of the AV comprises a software restriction corresponding to the autonomous operation of the AV.

Aspect 12. The method of any of Aspects 8 to 11, wherein initiating the switch comprises requesting assistance from the human operator.

Aspect 13. The method of any of Aspects 8 to 12, further comprising providing at least one of a pose and a location of the AV within the facility to the human operator.

Aspect 14. The method of Aspect 13, further comprising modifying, via the instruction from the human operator, at least one of the pose and the location of the AV within the facility.

Aspect 15. A non-transitory computer-readable storage medium comprising at least one instruction for causing a computer or processor to perform a method according to any of Aspects 8 to 14.

Aspect 16. A computer-program product comprising instructions which, when executed by one or more processors, cause the one or more processors to perform a method according to any of Aspects 8 to 14.

Aspect 17. A system comprising means for performing a method according to any of Aspects 8 to 14.

Aspect 18. A vehicle comprising a computing device configured to perform a method according to any of Aspects 8 to 14, wherein the vehicle is the autonomous vehicle.

Aspect 19. A vehicle comprising means for performing a method according to any of Aspects 8 to 14, wherein the vehicle is the autonomous vehicle.

What is claimed is:

1. A system comprising:
at least one memory; and
at least one processor coupled to the at least one memory, the at least one processor configured to:
navigate an autonomous vehicle (AV) to at least one of a facility and a location within the facility;
determine an error condition encountered by the AV in the facility, the error condition comprising at least one of a failure to perform a maneuver in the facility and a restriction of the AV preventing the AV from performing the maneuver in the facility;
in response to the error condition, initiate a switch of an operation of the AV from an autonomous operation to a human-controlled operation;
receive, from a human operator, an instruction for the AV to perform one or more maneuvers determined to resolve the error condition, wherein the one or more maneuvers comprise the maneuver or an alternative maneuver; and
trigger the AV to perform the one or more maneuvers based on the instruction.

2. The system of claim 1, wherein the at least one processor is further configured to:
in response to performing the one or more maneuvers, switch the operation of the AV from the human-controlled operation to the autonomous operation.

3. The system of claim 1, wherein the maneuver relates to parking, unparking, entering the facility, exiting the facility, and queuing.

4. The system of claim 1, wherein the determining the error condition comprises determining that performing or completing the maneuver includes violating the restriction of the AV, wherein the restriction of the AV comprises a software restriction corresponding to the autonomous operation of the AV.

5. The system of claim 1, wherein initiating the switch comprises requesting assistance from the human operator.

6. The system of claim 5, wherein the at least one processor is further configured to:
provide at least one of a pose and a location of the AV within the facility to the human operator.

7. The system of claim 6, wherein the at least one processor is further configured to:
modify, via the instruction from the human operator, at least one of the pose and the location of the AV within the facility.

8. A computer-implemented method comprising:
navigating an autonomous vehicle (AV) to at least one of a facility and a location within the facility;
determining an error condition encountered by the AV in the facility, the error condition comprising at least one of a failure to perform a maneuver in the facility and a restriction of the AV preventing the AV from performing the maneuver in the facility;
in response to the error condition, initiating a switch of an operation of the AV from an autonomous operation to a human-controlled operation;
receiving, from a human operator, an instruction for the AV to perform one or more maneuvers determined to resolve the error condition, wherein the one or more maneuvers comprise the maneuver or an alternative maneuver; and
triggering the AV to perform the one or more maneuvers based on the instruction.

9. The computer-implemented method of claim 8, further comprising:
in response to performing the one or more maneuvers, switching the operation of the AV from the human-controlled operation to the autonomous operation.

10. The computer-implemented method of claim 8, wherein the maneuver relates to parking, unparking, entering the facility, exiting the facility, and queuing.

11. The computer-implemented method of claim 8, wherein the determining the error condition comprises determining that performing or completing the maneuver includes violating the restriction of the AV, wherein the restriction of the AV comprises a software restriction corresponding to the autonomous operation of the AV.

12. The computer-implemented method of claim 8, wherein initiating the switch comprises requesting assistance from the human operator.

13. The computer-implemented method of claim 12, further comprising providing at least one of a pose and a location of the AV within the facility to the human operator.

14. The computer-implemented method of claim 13, further comprising modifying, via the instruction from the human operator, at least one of the pose and the location of the AV within the facility.

15. A non-transitory computer-readable storage medium comprising at least one instruction for causing a computer or processor to:
navigate an autonomous vehicle (AV) to at least one of a facility and a location within the facility;
determine an error condition encountered by the AV in the facility, the error condition comprising at least one of a failure to perform a maneuver in the facility and a restriction of the AV preventing the AV from performing the maneuver in the facility;
in response to the error condition, initiate a switch of an operation of the AV from an autonomous operation to a human-controlled operation;
receive, from a human operator, an instruction for the AV to perform one or more maneuvers determined to resolve the error condition, wherein the one or more maneuvers comprise the maneuver or an alternative maneuver; and
trigger the AV to perform the one or more maneuvers based on the instruction.

16. The non-transitory computer-readable storage medium of claim 15, wherein the at least one instruction is further configured to:
modify the switch the operation of the AV from the human-controlled operation to the autonomous operation in response to performing the one or more maneuvers.

17. The non-transitory computer-readable storage medium of claim 15, wherein the maneuver relates to parking, unparking, entering the facility, exiting the facility, and queuing.

18. The non-transitory computer-readable storage medium of claim 15, wherein the determining the error condition comprises determining that performing or completing the maneuver includes violating the restriction of the AV, wherein the restriction of the AV comprises a software restriction corresponding to the autonomous operation of the AV.

19. The non-transitory computer-readable storage medium of claim 15, wherein initiating the switch comprises requesting assistance from the human operator.

20. The non-transitory computer-readable storage medium of claim 19, wherein the at least one instruction is further configured to:
provide at least one of a pose and a location of the AV within the facility to the human operator; and
modify, via the instruction from the human operator, at least one of the pose and the location of the AV within the facility.
